(19) United States
(12) Patent Application Publication
(10) Pub. No.: US 2019/0197810 A1
(43) Pub. Date: Jun. 27, 2019

(54) TECHNIQUES FOR ASSESSING VOTER TURNOUT

(71) Applicant: JMH Consulting Group, LLC, Winchester, MA (US)

(72) Inventor: John Michael Herbert, Winchester, MA (US)

(73) Assignee: JMH Consulting Group, LLC, Winchester, MA (US)

(21) Appl. No.: 16/224,481

(22) Filed: Dec. 18, 2018

Related U.S. Application Data
(60) Provisional application No. 62/607,282, filed on Dec. 18, 2017.

(51) Int. Cl. G07C 13/00; H04W 4/02

(52) U.S. Cl. CPC G07C 13/00; G06Q 2230/00; H04W 4/023

(57) ABSTRACT

Apparatus and methods for assessing possible user voting activity are provided. For example, in one technique, activity is assessed based on a user's geographical location and/or time spent in a particular geographical location associated with a polling location. Activity of a mobile device may be assessed in some embodiments as part of determining one or more voting metrics for a voting event.

### CROSS-REFERENCE TO RELATED APPLICATIONS

The present application claims the benefit of 35 U.S.C. § 119(e) of U.S. Provisional Patent Application No. 62/607,282, filed Dec. 18, 2017, titled “Techniques for Assessing Voter Turnout,” which is hereby incorporated by reference in its entirety.

### TECHNICAL FIELD

Embodiments of the present invention relate to techniques for assessing voter turnout, and in particular to techniques for using geolocation and related methodologies, to assess voter turnout for voting events.

### BACKGROUND

Voting is one of the more traditional mechanisms used by a group to make decisions or to resolve issues. For example, voting can be used to elect officials or to decide contested issues, ranging from presidential elections to local elections, changes in law, and the like.

Various voting technologies have been used over the years, including electronic polls and automated statistics collection. While voting can be an important decision-making mechanism, it can also be inconvenient for voters. For example, because voting activities are usually confined to predetermined times and/or geographical locations, voters can be subject to long wait times, and may be required to travel long distances to vote (e.g., if the voter works far away from their designated polling location). Such inconveniences, coupled with other uncontrollable factors, such as family responsibilities, employment obligations, vacations, and the like, can result in polls being under-attended by otherwise willing and able voters.

### SUMMARY

According to one embodiment, a computerized method is provided for assessing activity of a mobile device associated with an user enrolled for a voting event. The method includes storing data associated with a voting event, the data comprising criteria for the voting event and a set of users enrolled for the voting event. Another act includes receiving geolocation data indicative of a geographical location of a mobile device associated with an enrolled user in the set of enrolled users. The method further comprises an act of determining, based on the geolocation data, an amount of time the mobile device spent relative to a polling location associated with the enrolled user. And an act is included to calculate, based on (a) the amount of time. (b) the criteria for the voting event, and (c) data associated with other enrolled users in the set of enrolled users, one or more voting metrics for the voting event.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a diagram of an exemplary system according to some embodiments;

FIG. 2 is a diagram of an exemplary voting platform computing device 104, according to some embodiments:

FIG. 3 is a flow chart showing an exemplary method for assessing an enrolled voter's activity based on geolocation technologies, according to some embodiments; and

FIG. 4 is a flow chart showing an exemplary method for analyzing voting data collected for enrolled voters for a voting event, according to some embodiments.

### DETAILED DESCRIPTION

Described herein are various embodiments of techniques for assessing geographical proximity to polling locations for voting events, including time spent within certain geographical areas associated with polling events.

Applicant has recognized and appreciated the difficulties that voting can place on members of a voting population, whether it be citizens of a jurisdiction, members of an organization, and/or the like. Applicant has developed techniques to automatically assess possible user voting activity. For example, in one technique, activity is assessed based on a user's geographical location and/or time spent in a particular geographical location associated with a polling location. Applicant has also developed techniques to automatically provide members of the voting population with advertisements and/or other benefits for completing voting activity. These and other techniques are discussed further herein.

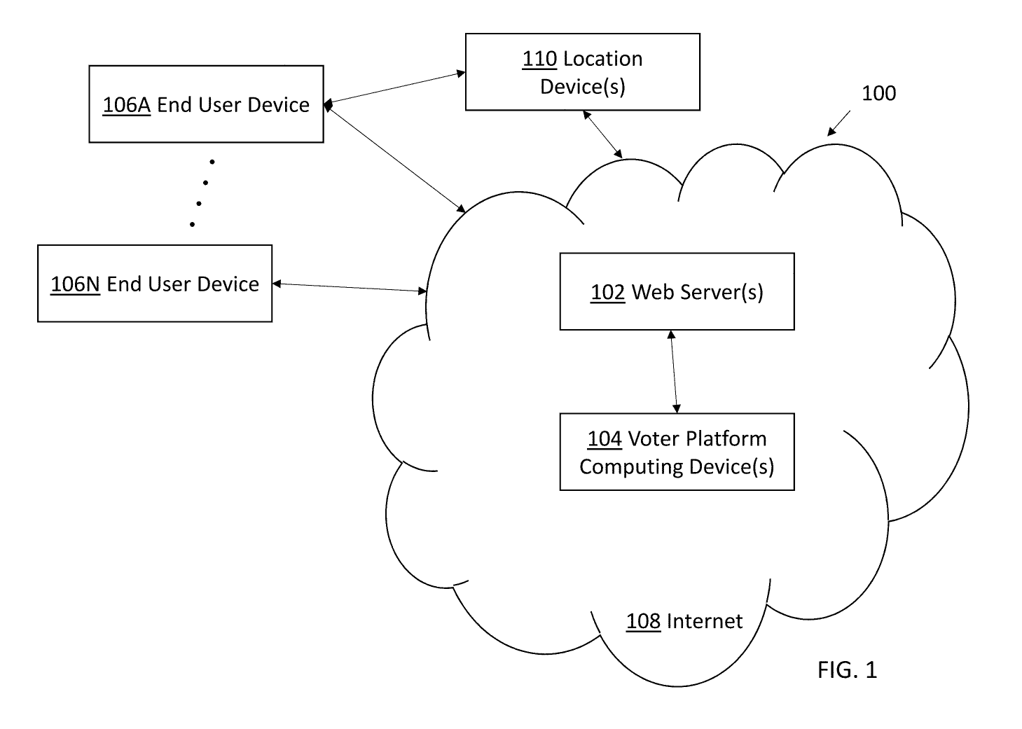

FIG. 1 is a diagram of an exemplary system 100, according to some embodiments. The system includes one or more web servers 102 (collectively referred to herein as web server 102) in communication with one or more voting platform computing devices 104 (collectively referred to herein as voter platform 104). The web server 102 and/or voter platform 104 are in communication with end user devices 106A-106N (collectively referred to as end user devices 106) via the Internet 108. The web server 102 and/or voter platform 104 are also in communication with optional location device(s) 110 (collectively referred to herein as location device 110).

Referring to the web server 102, the web server 102 can provide a web server functionality to serve a web-based user interface that allows users (e.g., users of the end user devices 106) to create an account with the voter platform 104. For example, the techniques disclosed herein can include a sign-up functionality for voters to enroll in the voter platform 104. As part of the account creation process, voters can enter relevant information, such as a phone number, address, and/or other identifying information. As discussed further herein, users can also configure various settings designed for the voter platform 104 to be able to provide targeted rewards and/or advertisements to the voter, where legal. Voters can also configure other settings, such as controlling calls, text messages, and/or application notifications regarding voting activities, such as estimated voting wait time updates, precinct/poll location, voting reminders, and/or the like. Additionally, a user can select one or more voting activities that are being supported by the voter platform 104 to enroll for the voting activity, such that if the user votes for the selected voting activity, the user can receive advertisements and/or rewards, as discussed further herein.

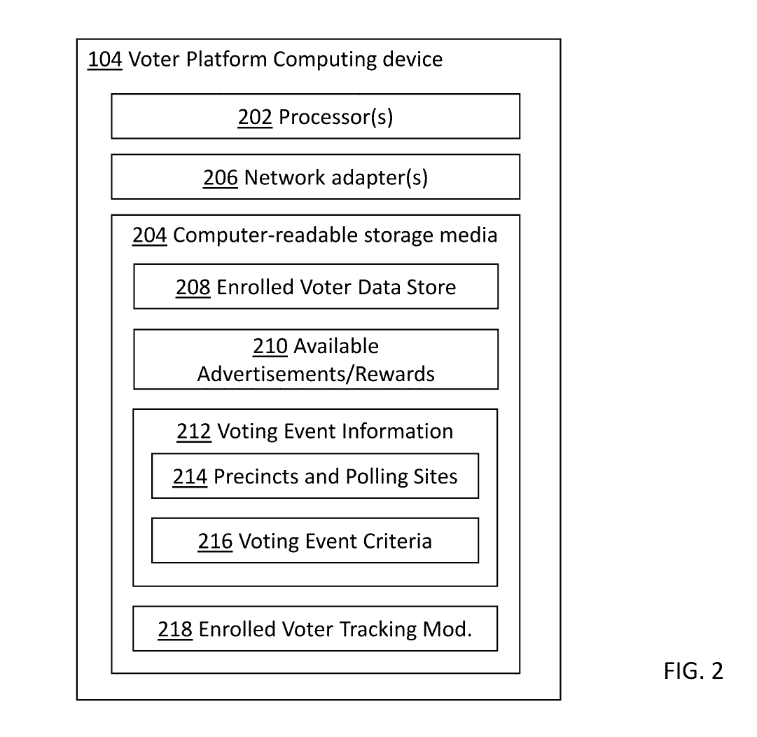

The voter platform 104 is discussed further in conjunction with FIG. 2. While the computing device 104 is shown separate from the web servers 102, this is merely illustrative, since a person of skill in the art will appreciate that the functionality of the web servers and/or the voting platform computing devices can be incorporated into one or more of the same devices and need not be separate devices. Additionally, or alternatively, the web server 102 and/or voter platform 104 can be embodied in one or more cloud-based computing devices, such as to support large-scale voting activities, such as national elections.

Referring to the end user devices 106, the end user devices can be, for example, a cell phone, smart phone, personal digital assistant, computer, and/or any other device used by the user to access the voter platform 104.

Referring to the location device 110, the location device 110 can provide information regarding enrolled voter locations, including determining the enrolled voter's proximity to an associated voting event, as well as the duration of time that the enrolled voter was in proximity to the associated voting event. The location device 110 can be a device installed at polling locations and configured to assess the attendance of voters that enrolled/registered with the voter platform 104 to confirm whether each enrolled voter actually voted in the particular voting activity and/or confirm that the enrolled voter attended the voter's polling site for a time period indicative of a sufficient likelihood that the voter did, in fact, vote for a voting activity that the user selected. For example, the location device 110 can be a smart card reader configured to read smart cards associated with enrolled voters (e.g., which the enrolled voters receive prior to the voting activity to identify the enrolled voter and confirm the enrolled voter attended the voter's polling location). As another example, the location device 110 can be a computing device configured with an interface that allows enrolled voters to enter an authentication token associated with the enrolled voter (which the enrolled voter receives prior to the voting activity, and/or accesses through the enrolled voter's account with the 20 voter platform 104).

Referring further to location device 110, in some embodiments as discussed above, use of such a location device 110 is optional, and/or can be incorporated into existing functionality associated with the polling site. For example, WiFi routers and/or access points already pre-installed in the polling site can be used to determine whether the enrolled voter was physically present at the enrolled voter's polling cite (e.g., via WiFi signals transmitted from a device associated with the user, such as a WiFi-compatible smart phone). As another example, cell phone base stations and/or cell phone access points can be used to determine that the enrolled voter was physically present at the enrolled voter's polling cite (e.g., via cellular signals from a cellular device associated with the user, such as a cell phone or smart phone). As a further example, geolocation can be used, based on WiFi and/or cellular signals, and/or using GPS-based devices, such as a GPS unit in a vehicle associated with an enrolled voter, and/or GPS-assisted devices, such as GPS-assisted location-based components of smart phones.

FIG. 2 shows a diagram of an exemplary voting platform computing device 104, according to some embodiments. The voter platform 104 includes one or more processors 202 configured to execute machine readable instructions configured to cause the one or more processors 202 to carry out the techniques described herein (e.g., which can be stored in the computer-readable storage media 204). The voting platform also includes one or more network adapters 206 configured to connect the voter platform 104 with a network, such as the Internet 108 in FIG. 1. The computer-readable storage media 204 can include a number of different components, such as those shown in FIG. 2, including an enrolled voter data store 208, available advertisements/rewards 210, a voting event information 212, and a enrolled voter tracking module 218.

The enrolled voter data store 208 can be configured to maintain the set of voters that have enrolled/registered with the system, as well as other related account settings and preferences as discussed herein (e.g., settings related to selected voting activities, locations, times, associated precinct/polling sites, etc.).

The available advertisements/rewards 210 keeps track of available advertisements and/or rewards, or other data, that can be provided to enrolled voters, as discussed further below. For example, the advertisements or rewards can include coupons for nearby restaurants or businesses, parking vouchers, point (or cash) rewards, and the like. The voter platform 104 can be configured to allow advertisers to partner with the voting platform to add/incorporate deals, coupons, etc. As another example, the voter platform 104 can provide enrolled voters with a reminder to vote if the voter platform 104 has not determined that a user likely voted for an enrolled voting event and the time for the enrolled voting event is nearing completion. In some examples, the voter platform 104 can provide targeted policy messages or vote reminders to mobile devices associated with enrolled voters, including based on past and present data. In some examples, the voting platform can present an enrolled voter, via the enrolled user's mobile device, with an offer for a ride if it is getting late in the day and there is no indication of the enrolled voter having been near the enrolled voter's associated polling location.

The voting event information 212 includes associated precincts and polling sites 214 (if applicable), and voting event criteria 216 that describe further criteria related to the polling site, such as any restrictions on advertisements or rewards. For example, if the election is a federal election, the voter platform 104 can be configured such that the stored advertisements or rewards associated with the voting event can be made available to the public rather than just based on likely voting activity. If the election is in a jurisdiction or institution that allows rewards or coupons to be provided to people who have voted or have likely voted, such information could be stored as voting event information. The voting events criteria 216 can also include data indicative of what constitutes a likely voting attendance for a enrolled voter, such as a minimum time duration for a enrolled voter to be geographically within a particular proximity of the enrolled voter's voting site, and/or the like.

The enrolled voter activity tracking module 218 is configured to track the time and location of the user (e.g., using the user's end user device 106 and/or location devices 110), such as to determine whether a user meets criteria associated with the voting event information 212 such that the user qualifies to receive the advertisements and/or rewards associated with the voting event. The activity tracking module 218 uses the obtained data to determine whether the enrolled voter is likely to have voted during the voting event.

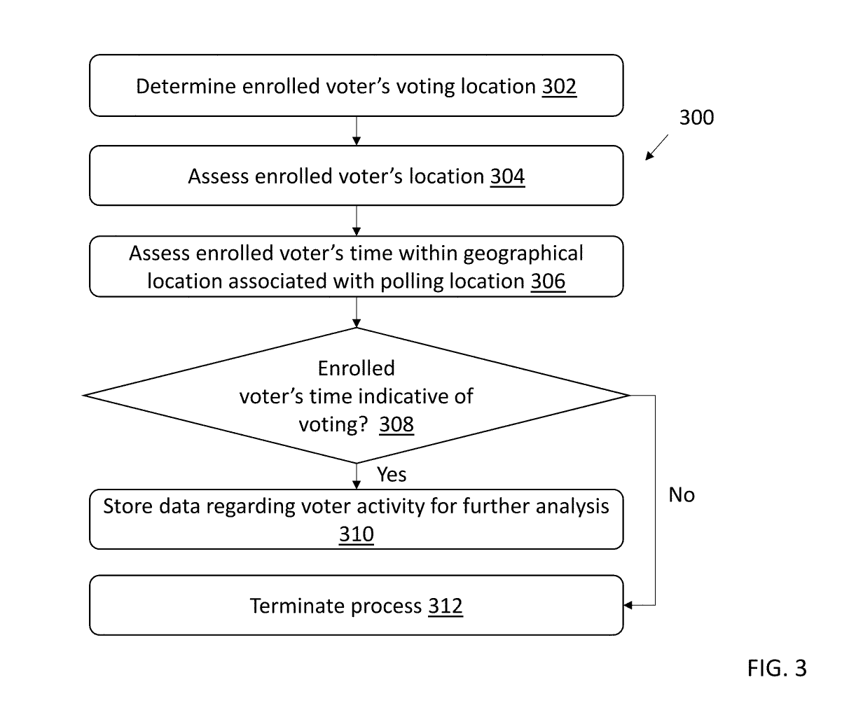

FIG. 3 is a flow chart showing an exemplary method 300 for assessing an enrolled voter's activity based on geolocation technologies, according to some embodiments. At step 302, the system (e.g., the voter platform 104) determines the enrolled voter's voting location. For example, if the voting event is only associated with a single location, then that single location is used. As another example, if the voting event is associated with various precincts, each with associated polling locations, then the enrolled voter is matched with the enrolled voter's assigned polling location for the associated voting event. For example, when registering, the voter can add an associated address via the registration program, which the system can use to determine the voter's precinct and polling site, and optionally can display the polling site to the user.

At step 304, the system assesses the enrolled voter's location, e.g., during active voting times associated with the voting event. For example, the voting system can use location-based techniques, such as GPS-based or GPS-assisted techniques, to assess the user's location to determine when the enrolled voter enters within a particular predetermined area associated with the enrolled voter's voting/polling site. For example, the system can include a predetermined geographic area at or around the polling location, including based on whether the enrolled voter is within WiFi range of the polling location (or devices associated with the polling location), within cellular range of a cellular base station associated with the polling location, registers a location, using GPS technologies, that is within the geographic area, and/or the like.

At step 306, once the system determines that the enrolled voter is within a particular predetermined geographic area associated with the polling location, the system assesses the enrolled voter's time within the geographical location to determine the duration of time that the user is sufficiently near the polling location.

At step 308, the system determines whether the duration that the enrolled voter was within the polling location is indicative of the enrolled voter having completed a voting activity. For example, the system may determine whether the voter was presented at the polling location for more than a threshold amount of time. As another example, the system can be configured to assess the average wait time for voting at each polling location, as well as the average time taken to actually vote. The system can be configured to calculate, for each polling site, a running estimated time for voting based on the current average wait time, average time taken to actually vote, and/or an additional time buffer (e.g., an additional time period allotted for slower voters, handicapped access, and/or the like). The system may also retrieve such information from any suitable source, such as a government (e.g., local or state government) agency that provides such information, or from a non-government agency that collects and publishes such information. The wait time may be determined and retrieved contemporaneous with a voting event, such that the wait time is indicative of an actual wait time during the voting event. The wait time may additionally or alternatively be based on past wait times experienced at the polling location, such as during one or more prior elections, such that the wait time is a prediction of a wait time that a voter may experience at the voting event. The system can compare the duration that the enrolled user was within the associated geographical location to the estimated time for voting to make a determination of whether the enrolled voter was at the location for a sufficient period of time to have carried out a voting activity.

For example, if the average weight time when the enrolled voter enters a sufficient proximity of the polling location is 30 minutes, but the enrolled voter is only within a proximity of the polling location for five minutes, the system may determine that the enrolled voter did not complete a voting activity (e.g., the enrolled voter arrived at the polling location but decided not to wait in line). As another example, if the average weight time when the enrolled voter enters a sufficient proximity of the polling location is 30 minutes, and the enrolled voter was within a proximity of the polling location for an hour, the system may determine that the enrolled voter did complete a voting activity (e.g., the enrolled voter arrived at the polling location and stayed after voting to talk with friends).

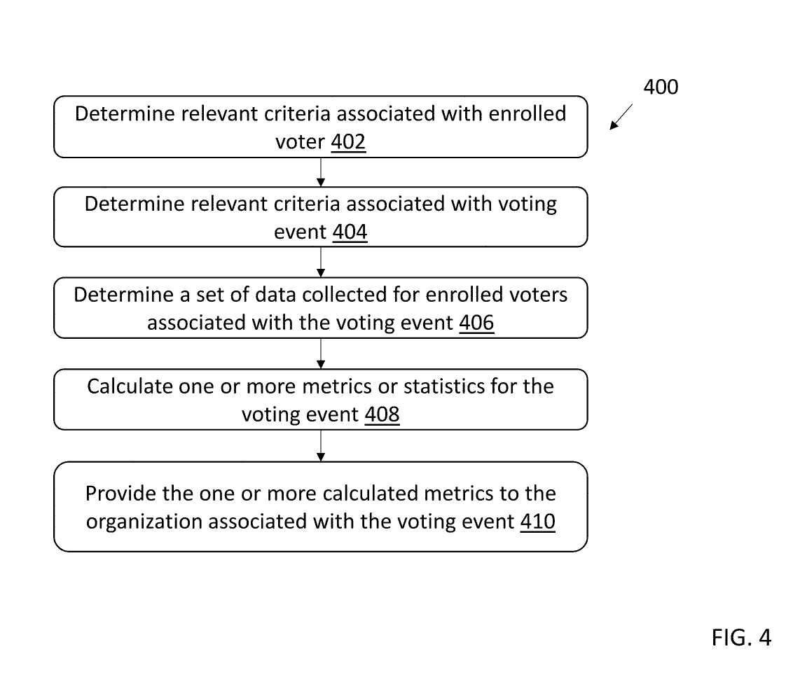

If the determination at step 308 is that the voter likely completed a voting activity, the system proceeds to step 310 and stores data associated with the voter for further analysis, as discussed further below in conjunction with FIG. 4. For example, a campaign or government body can analyze the data collected over the course of a voting event to determine voter turnout, what groups of voters turned out at what rate (e.g., based on age, gender, rural, and/or the like, including other data associated with enrolled voters), and/or other statistics associated with the voting event. In some examples, advertisements and/or awards could be sent to enrolled voters, as discussed further herein. For example, the system can determine one or more advertisements and/or awards to present to the enrolled voter (e.g., via an app, web interface, mail, and/or the like). Otherwise, the process proceeds to step 312 and the process terminates without storing data indicative of the enrolled voter having likely completed a voting activity.

FIG. 4 is a flow chart showing an exemplary method 400 for analyzing voting data collected for enrolled voters for a voting event, according to some embodiments. At step 402, the system determines relevant criteria associated with enrolled voters. For example, the system can determine a home location of the enrolled voter, a current location of the enrolled voter, the voter's associated polling location for the voting event, demographics of the voter, political preferences of the voter, whether the enrolled voter has configured any relevant settings in the platform (e.g., preferences, such as favorite restaurants, allergies, and/or the like), and/or other relevant criteria that can be used to identify relevant ads or awards for the enrolled voter. The system can also determine the enrolled voters activity history, e.g., which can be used to provide higher-value coupons or awards to encourage continued use of the platform.

At step 404, the system determines relevant criteria associated with the voting event. For example, the system can determine that the voting event includes preferences, such as preferences configured by an entity associated with the voting event, such as a campaign or governmental entity or other organization. For example, preferences can include desired statistics or metrics to analyze based on enrolled voter activity for a voting event, such as voter turnout, turnout of particular groups and at what rate, average time required to vote, most (and/or least) popular voting times, and/or other statistics or metrics associated with the voting event. As a further example, the system can determine the amount of time it took an enrolled voter to vote. As another example, the system can determine whether the voting event has any restrictions on advertisements and/or awards (e.g., for a federal election, the laws may require any ads or awards to be made available to all members of the public, whereas other types of voting events may not have such restrictions).

At step 406, the system determines a set of data collected for enrolled voters associated with the voting event. For example, the system can be configured to store data indicative of enrolled voters that likely completed a voting activity and/or did not complete a voting activity. The set of data can include data indicative of all enrolled voters for the voting event. The set of data can also include geographical data associated with enrolled voters for the voting event during the voting times of the voting event.

At step 408, the system can calculate one or more metrics or statistics associated with the voting event. For example, the system can calculate one or more metrics or statistics as specified by the relevant criteria for the voting event discussed in conjunction with step 404, such as voter turnout, metrics based on certain groups of voters, popular (or unpopular) voting times, average voting time, travel time required to vote, and/or the like.

At step 410, the system can provide the calculated metrics or statistics to the organization that ran the voting event. For example, the organization can be registered with the voter platform such that the system can provide the metrics/statistics to the registered organization, including through text message, email, etc. In some examples, the system can transmit the data to the organization, and/or can make the data available to the organization, such as through a mobile application, web application, and/or the like.

In some examples, the system can match enrolled voters up with coupons/rewards, including based on location, demographics, political preferences, user preferences, other available information (e.g., children, personal interests, etc.). The system can select one or more of the advertisements or awards for the enrolled voter. For example, while a number of restaurant coupons may be available for the system can select one of such coupons to match the enrolled voter's eating preferences, geographical location, and/or the like. As another example, if the enrolled voter is associated with criteria indicating the enrolled voter should be provided with a highest-value ad or award (e.g., based on an accumulated points basis for the system for continued use of the system over time, based on a long time taken to vote, based on a long distance traveled to the polling location, etc.), the system can select the highest-value award for the user. As a further example, if the voting event requires all ads/awards to be provided to all members of the general public, such as for a federal vote, then the system can be configured to help the user identify ads/awards relevant to the specific user, such as based on enrolled voter preferences, the enrolled voter's location, and/or the like. e.g., to make it easier for the enrolled voter to take advantage of the ads/awards. As another example, the system can be configured to analyze, e.g., based on feedback statistics or other data, particular types of rewards being heavily utilized and to use such information to identify a similar reward for the enrolled voter.

Techniques operating according to the principles described herein may be implemented in any suitable manner. Included in the discussion above are a series of flow charts showing the steps and acts of various processes that are used to determine likely voting activities of enrolled voters, and to pair enrolled voters up with relevant ads/coupons/awards, etc. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application, such as geospatial assessment, web serving, and/or database management, and/or the like.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 204 of FIG. 2 described below (i.e., as a portion of a computing device voter platform computing device 104) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 2, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

FIG. 2, as discussed above, illustrates one exemplary implementation of a computing device in the form of a computing device 104 that may be used in a system implementing techniques described herein, although others are possible. It should be appreciated that FIG. 2 is intended neither to be a depiction of necessary components for a computing device to operate as a voter platform in accordance with the principles described herein, nor a comprehensive depiction.

Computing device 104 (and/or the end user devices 106) may be, for example, a desktop or laptop personal computer, a personal digital assistant (PDA), a smart mobile phone, a server, a wireless access point or other networking element, or any other suitable computing device. Network adapter 206 may be any suitable hardware and/or software to enable the computing device 104 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 204 may be adapted to store data to be processed and/or instructions to be executed by processor 202. Processor 202 enables processing of data and execution of instructions. The data and instructions may be stored on the computer-readable storage media 204.

The data and instructions stored on computer-readable storage media 204 may comprise computer-executable instructions implementing techniques which operate according to the principles described herein. In the example of FIG. 2, computer-readable storage media 204 stores computer-executable instructions implementing various facilities and storing various information as described above.

While not illustrated in FIG. 2, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

1. A computerized method for assessing activity of a mobile device associated with an user enrolled for a voting event, the method comprising:
storing data associated with a voting event, the data comprising criteria for the voting event and a set of users enrolled for the voting event;
receiving geolocation data indicative of a geographical location of a mobile device associated with an enrolled user in the set of enrolled users;
determining, based on the geolocation data, an amount of time the mobile device spent relative to a polling location associated with the enrolled user; and
calculating, based on (a) the amount of time, (b) the criteria for the voting event, and (c) data associated with other enrolled users in the set of enrolled users, one or more voting metrics for the voting event.

2. The method of claim 1, further comprising determining the polling location based on a physical address associated with the enrolled user.
